(19) United States
(12) Patent Application Publication
(10) Pub. No.: US 2009/0311661 A1
(43) Pub. Date: Dec. 17, 2009

(54) DEMONSTRATIVE METHODS FOR TOILET TISSUE PRODUCTS

(76) Inventors: Gregg Thomas Weaver, Liberty Township, OH (US); Mark Casey Fox, Milford, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/138,797

(22) Filed: Jun. 13, 2008

(51) Int. Cl. G09B 25/00; B65D 85/00

(52) U.S. Cl. 434/367; 206/389

(57) ABSTRACT

Demonstrative methods for sanitary tissue products, for example toilet tissue products, and more particularly, methods for demonstrating wet pilling differences between two or more toilet tissue products and toilet tissue product packages and marketing articles that evidence wet pilling differences between toilet tissue products are provided.

### FIELD OF THE INVENTION

The present invention relates to demonstrative methods for sanitary tissue products, for example toilet tissue products, and more particularly, to methods for demonstrating wet pilling differences between two or more toilet tissue products and toilet tissue product packages and marketing articles that evidence wet pilling differences between toilet tissue products.

### BACKGROUND OF THE INVENTION

Consumers of toilet tissue products continue to demand more and more improved properties in their toilet tissue products. As a result, formulators are continually trying to improve upon toilet tissue product properties that are desired by consumers. However, formulators are faced with trying to communicate to the consumers, especially in a meaningful, clear and visual manner, their toilet tissue product's improved property compared to other toilet tissue products. In particular, to date no one has been able to meaningfully, clearly and/or visually evidence to consumers their toilet tissue product's improved wet pilling property.

Accordingly, there is a need for a method for demonstrating to a consumer wet pilling property differences between two or more toilet tissue products; and toilet tissue product packages and marketing articles that evidence different wet pilling properties of different toilet tissue products.

### SUMMARY OF THE INVENTION

The present invention fulfills the needs described above by providing a method for demonstrating to a consumer wet pilling property differences between two or more sanitary tissue products, for example toilet tissue products; and toilet tissue product packages and marketing articles that evidence different wet pilling properties of different sanitary tissue products, for example toilet tissue products.

In one example of the present invention, a method for demonstrating to a consumer wet pilling property differences between two toilet tissue products, the method comprising the steps of:

a. subjecting a first toilet tissue product and a second toilet tissue product to a wet pilling test method, which produces results that demonstrate to a consumer the wet pilling property differences between the first and second toilet tissue products; and

b. presenting the results to the consumer, is provided.

In another example of the present invention, a toilet tissue product package comprising a non-textual indicia that evidences to a consumer of the toilet tissue product package that the toilet tissue product exhibits a wet pilling property different from another toilet tissue product, is provided.

In yet another example of the present invention, a marketing article comprising non-textual indicia that evidences to a consumer of a toilet tissue product that the toilet tissue product exhibits a wet pilling property different from another toilet tissue product, is provided.

Accordingly, the present invention provides a method for demonstrating to a consumer wet pilling property differences between two or more toilet tissue products; and toilet tissue product packages and marketing articles that evidence different wet pilling properties of different toilet tissue products.

### BRIEF DESCRIPTION OF THE DRAWINGS

FIG. 1 is a schematic representation of an example of a sanitary tissue product package, for example a toilet tissue product package, according to the present invention;

FIG. 2 is a schematic representation of an example marketing article according to the present invention; and

FIG. 3 is a schematic representation of an example of a method for demonstrating to a consumer wet pilling property differences between toilet tissue products according to the present invention.

### DETAILED DESCRIPTION OF THE INVENTION

### Definitions

“Fiber” as used herein means an elongate particulate having an apparent length greatly exceeding its apparent diameter, i.e. a length to diameter ratio of at least about 10. Fibers having a non-circular cross-section are common; the “diameter” in this case may be considered to be the diameter of a circle having cross-sectional area equal to the cross-sectional area of the fiber. More specifically, as used herein, “fiber” refers to fibrous structure-making fibers. The present invention contemplates the use of a variety of fibrous structure-making fibers, such as, for example, natural fibers, including wood fibers, or synthetic fibers made from natural polymers and/or synthetic fibers, or any other suitable fibers, and any combination thereof.

“Fibrous structure” as used herein means a structure (web) that comprises one or more fibers. Nonlimiting examples of processes for making fibrous structures include known wet-laid fibrous structure making processes, air-laid fibrous structure making processes, meltblowing fibrous structure making processes, co-forming fibrous structure making processes, and spunbond fibrous structure making processes. Such processes typically include steps of preparing a fiber composition, oftentimes referred to as a fiber slurry in wet-laid processes, either wet or dry, and then depositing a plurality of fibers onto a forming wire or belt such that an embryonic fibrous structure is formed, drying and/or bonding the fibers together such that a fibrous structure is formed, and/or further processing the fibrous structure such that a finished fibrous structure is formed. The fibrous structure may be a through-air-dried fibrous structure and/or conventionally dried fibrous structure. The fibrous structure may be creped or uncreped. The fibrous structure may exhibit differential density regions or may be substantially uniform in density. The fibrous structure may be pattern densified, conventionally felt-presses and/or high-bulk, uncompacted. The fibrous structures may be homogenous or multilayered in construction.

After and/or concurrently with the forming of the fibrous structure, the fibrous structure may be subjected to physical transformation operations such as embossing, calendering, selfing, printing, folding, softening, ring-rolling, applying additives, such as latex, lotion and softening agents, combining with one or more other plies of fibrous structures, and the like to produce a finished fibrous structure that forms and/or is incorporated into a sanitary tissue product.

“Sanitary tissue product” as used herein means a wiping implement for post-urinary and/or post-bowel movement cleaning (toilet tissue), for otorhinolaryngological discharges (facial tissue) and/or multi-functional absorbent and cleaning uses (absorbent towels such as paper towels and/or wipes).

The sanitary tissue products of the present invention may comprise one or more fibrous structures and/or finished fibrous structures.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit a total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit a density of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in any suitable form, such as in a roll, in individual sheets, in connected, but perforated sheets, in a folded format or even in an unfolded.

The sanitary tissue products of the present invention may comprises additives such as softening agents, temporary wet strength agents, permanent wet strength agents, bulk softening agents, lotions, silicones, and other types of additives suitable for inclusion in and/or on sanitary tissue products.

“Ply” or “plies” as used herein means an individual finished fibrous structure optionally to be disposed in a substantially contiguous, face-to-face relationship with other plies, forming a multiple ply (“multi-ply”) sanitary tissue product. It is also contemplated that a single-ply sanitary tissue product can effectively form two “plies” or multiple “plies”, for example, by being folded on itself.

“Machine Direction” or “MD” as used herein means the direction parallel to the flow of the fibrous structure through the papermaking machine and/or product manufacturing equipment. In one example, once incorporated into a sanitary tissue product, the MD of the fibrous structure may be the MD of the sanitary tissue product.

“Cross Machine Direction” or “CD” as used herein means the direction perpendicular to the machine direction in the same plane of the fibrous structure. In one example, once incorporated into a sanitary tissue product, the CD of the fibrous structure may be the CD of the sanitary tissue product.

“Evidence” and/or “evidences” as used herein means that a toilet tissue package, toilet tissue and/or marketing article comprises non-textual indicia that conveys information to a consumer about a toilet tissue product. In one example, the information about the toilet tissue product may be conveyed intuitively from non-textual indicia present on a toilet tissue package, toilet tissue and/or marketing article to a consumer.

“Intuitively” as used herein means that a consumer interprets non-textual indicia based on the consumer's previous life experiences and/or knowledge.

“Indicia” as used herein means an indicator that conveys information to a consumer.

“Textual indicia” as used herein means text indicia, such as a word and/or phrase that conveys information to a consumer. In one example, a toilet tissue product is housed in a package comprising a textual indicia; namely, the word “strong.”

“Brand name” as used herein means a single source identifier, in other words, a brand name identifies a product and/or service as exclusively coming from a single commercial source (i.e., company). An example of a brand name is Charmin®, which is also a trademark. Brand names are nonlimiting examples of textual indicia. The sanitary tissue products of the present invention may be marketed and/or packaged under a common brand name (i.e., the same brand name, such as Charmin®). In addition to the brand name, a product descriptor may also be associated with the sanitary tissue products, such as “Ultra Strong” and/or “Ultra Soft” for example).

“Non-textual indicia” as used herein means non-text indicia that evidences information about a product to a consumer through a consumer's senses. In one example, non-textual indicia may evidence, even intuitively evidence, to a consumer through sight (visual indicia), through touch (texture indicia) and/or through smell (scent indicia).

Nonlimiting examples of non-textual indicia include pictures, graphs, drawings, representations such as product representations comparing two or more products, images, icons, colors, textures, patterns, such as emboss patterns and/or emboss pattern images, character representations, action representations, and mixture thereof.

As used herein, “basis weight” as used herein is the weight per unit area of a sample reported in lbs/3000 ft² or g/m². The basis weight is measured herein by the basis weight test method described in the Test Methods section herein.

“Wet Pilling” as used herein means elongated small particles containing a mixture of fibers generated by rubbing a slightly moistened sanitary tissue paper, for example toilet tissue product, over a surface as described in the Wet Pilling Test Method described herein. The surface may include skin, felt, or other slightly rough surface intended to mimic the pilling of the sanitary tissue product, for example toilet tissue product, as it is used to clean a portion of the human skin or skin/hair combination. These pieces are a result of the product abrading and/or tearing on a surface during the wiping process. When this happens, pieces of the sanitary tissue product, for example toilet tissue product, are removed from the sheet and then twisted or rolled together, culminating in elongated fiber strands or pills (ropes/snakes) of paper that are visibly left behind on the skin, hair, or other surface. Strands or pills larger than 5 mm² have been determined to be large enough to be noticeable by consumers on skin, and are therefore included in any quantitative measurements of pill number, density, etc.

As used herein, “texture” as used herein means any pattern present in the fibrous structure. For example, a pattern may be imparted to the fibrous structure during the fibrous structure-making process, such as during a through-air-drying step. A pattern may also be imparted to the fibrous structure by embossing the finished fibrous structure during the converting process and/or by any other suitable process known in the art.

### Method for Demonstrating to a Consumer

In one example, the wet pilling results obtained from the Wet Pilling Test Method for two or more sanitary tissue products, for example toilet tissue products, may comprise the number of pills produced by each of the sanitary tissue products, for example toilet tissue products; the size of pills produced by each of the sanitary tissue products, for example toilet tissue products and/or the surface area covered by the pills produced by each of the sanitary tissue products, for example toilet tissue products.

The results may be presented to consumers in various ways known to those skilled in the art. Nonlimiting examples of ways that the results may be presented to consumers include visually, numerically and/or graphically. Visually presenting the results may include conducting a simulated, in-use performance of the sanitary tissue product, for example toilet tissue product, in the presence of one or more consumers and then showing the results; showing the results to a consumer in person; and/or representing the results in an image, such as a photograph, to which a consumer has access.

Numerically presenting the results to consumers may include providing the number of pills and/or numerical sizes of the pills to the consumers.

Graphically presenting the results to consumers may include providing a graph that evidences the results.

The results may be presented in one or more of the following ways: airing a television commercial comprising the results; placing the results on the Internet; distributing a print advertisement comprising the results; distributing the results on sanitary tissue product packages, for example toilet tissue product packages; displaying the results on an in-store display; and/or displaying the results on a billboard.

The results may be obtained from the wet pilling test method described herein. The wet pilling test method may comprise the steps of: applying moisture, such as water, to a first and second sanitary tissue product, for example toilet tissue product; and wiping the moistened first and second toilet tissue products across a test surface, such as felt, simulated human skin, animal skin, actual human skin, such that the wet pilling property differences between the first and second sanitary tissue products, for example toilet tissue products, is evidenced, such as visible, to a consumer of a sanitary tissue product, for example toilet tissue product.

### Sanitary Tissue Product (for Example Toilet Tissue Product) Package

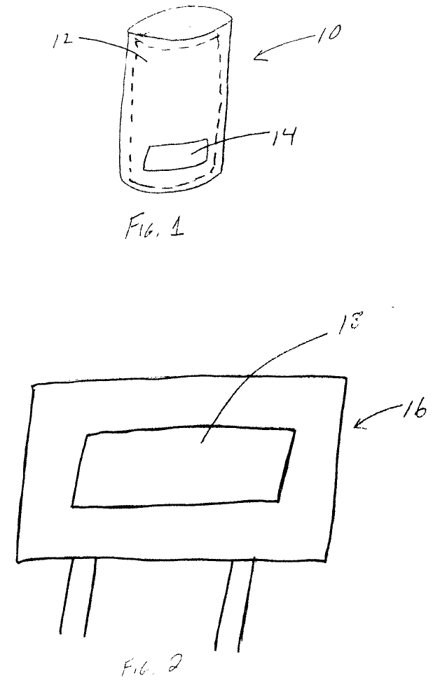

As shown in FIG. 1, a sanitary tissue product, for example toilet tissue product, package 10 according to the present invention houses a toilet tissue product 12, wherein the package 10 may comprise non-textual indicia 14 that evidences to a consumer of the toilet tissue product package 10 that the toilet tissue product 12 exhibits a wet pilling property different from another toilet tissue product.

The sanitary tissue product package 10 may comprise non-textual indicia 14 selected from the group consisting of: pictures, graphs, drawings, representations, images, icons and mixtures thereof.

### Marketing Article

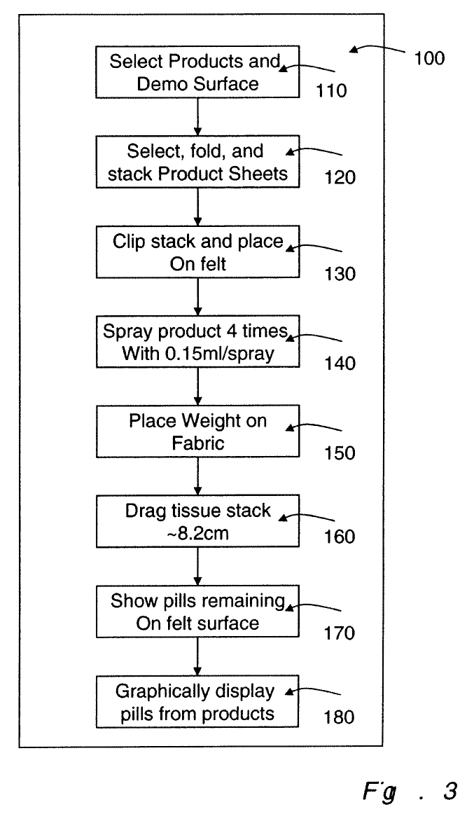

As shown in FIG. 2, a marketing article, for example a billboard, 16 may comprise non-textual indicia 18 that evidences to a consumer of a sanitary tissue product, for example a toilet tissue product, that the toilet tissue product exhibits a wet pilling property different from another toilet tissue product.

The marketing article 16 may comprise non-textual indicia 18 selected from the group consisting of: pictures, graphs, drawings, representations, images, icons and mixtures thereof.

The marketing article 16 may be selected from the group consisting of: print advertisements, in-store display advertisements, billboard advertisements, television advertisements, Internet advertisements and mixtures thereof.

### Test Methods

Unless otherwise indicated, all tests described herein including those described under the Definitions section and the following test methods are conducted on samples, fibrous structure samples and/or sanitary tissue product samples and/or handsheets that have been conditioned in a conditioned room at a temperature of 73° F.±4° F. (about 23° C.±2.2° C.) and a relative humidity of 50%±10% for 2 hours prior to the test. Further, all tests are conducted in such conditioned room. Tested samples and felts should be subjected to 73° F.±4° F. (about 23° C.±2.2° C.) and a relative humidity of 50%±10% for 2 hours prior to testing.

### Basis Weight Method:

Basis weight is measured by preparing one or more samples of a certain area (m²) and weighing the sample(s) of a fibrous structure according to the present invention and/or a sanitary toilet tissue product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

### Dry Tensile Strength Test Method:

One (1) inch by five (5) inch (2.5 cm×12.7 cm) strips of fibrous structure and/or sanitary toilet tissue product are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is the special case determined by the arithmetic total of MD and CD tensile strengths of the strips.

### Wet Tensile Strength Test Method:

An electronic tensile tester (Thwing-Albert EJA Materials Tester, Thwing-Albert Instrument Co., 10960 Dutton Rd., Philadelphia, Pa., 19154) is used and operated at a crosshead speed of 4.0 inch (about 10.16 cm) per minute and a gauge length of 1.0 inch (about 2.54 cm), using a strip of a fibrous structure and/or sanitary tissue product of 1 inch wide and a length greater than 3 inches long. The two ends of the strip are placed in the upper jaws of the machine, and the center of the strip is placed around a stainless steel peg (0.5 cm in diameter). After verifying that the strip is bent evenly around the steel peg, the strip is soaked in distilled water at about 20° C. for a soak time of 5 seconds before initiating cross-head movement. The initial result of the test is an array of data in the form load (grams force) versus crosshead displacement (centimeters from starting point).

The sample is tested in two orientations, referred to here as MD (machine direction, i.e., in the same direction as the continuously wound reel and forming fabric) and CD (cross-machine direction, i.e., 90° from MD). The MD and CD wet tensile strengths are determined using the above equipment and the Total Wet Tensile is determined by taking the sum of these two values.

### Wet Pilling Test Method

A schematic illustration of steps involved in the wet pilling test method of sanitary tissue products, for example toilet tissue products, is shown in FIG. 3. The overall method 100 is composed of a series of sequential steps selected to mimic how consumers use sanitary tissue products in real life conditions. However, the overall method 100 is done in a comparative manner so that the consumer can evaluate how different products within an array of branded products, or how products associated with different brands will perform under similar use conditions. These steps and conditions were selected based on actual in-use conditions measured via consumer testing.

The first step 110 of the process is simply to select two products for the side-by-side comparison of products and securing a hard, flat surface such as a kitchen counter top to conduct the demonstration upon.

The second step 120 involves removing 4 continuous and connected sheets of product from each of the two rolls, according folding and stacking the 4 sheets from each product into two stacks (embossed surface of the products facing out), one for each product, folding the 4 sheets from each stack in half (folding perpendicular to the Machine Direction) to create an 8 layer stack, and then clipping the 4 sheets together with a small binder clip (Item #6110624501 cut to about 12.5 cm length, Mercury Banner Hanging System™, Fasteners commercially available from Retail Company, Cleveland, Ohio, USA). The clip is connected to one of the two narrow ends of the stack so that when the tissue stack is pulled using the clip, the tissue is dragged along the MD axis of the tissue. The binder clip is connected to a either a cotton candle string, approximately 1 to 2 mm in diameter, or a small flexible steel wire capable of pulling the clip, sanitary towel stack, and weight across the surface of the felt. Eight layers of toilet tissue is about equivalent the average number of sheets used by consumers in a post-urinary cleansing process, as determined by a habits and practices study conducted by The Procter & Gamble Company in 2006.

The third step 130 involves placing the two folded stacks of products on identical textured surfaces intended to mimic human skin. The composition of the surface should integrate the effect of hair follicles on a wet sample in the context of a wipe. The ideal surface material to use for the demonstration would be an industry-accepted perineal analog that simulates topography, morphology, and surface characteristics of consumers' skin, including the presence of hair follicles. However, no commonly accepted standard exists. Plus, the high degree of variation in anatomy and hygiene habits within the population seems to make the task of identifying a single representative analog difficult. For this test method, a felt sample is used. The felt sample is a 6.5 cm wide by 21.6 cm long (Black Felt F-55 (GCAS No. 16007416), commercially available from Northern Textile Wool Felt, Bristol, Conn., USA) piece of felt is used. Such a felt sample has been used by The Procter & Gamble Company internally since 1971 as an acceptable human skin mimic standard with consistently repeatable results.

The fourth step 140 requires the application of 0.6 ml of water to a surface of each stack, dispensed through 4 sprays on each stack of tissue with each spray dispensing 0.15 ml of water. The sprays are alternated between stacks to minimize time and volume differences dispensed on the two stacks. The 1^{st} and 3^{rd} sprays are directed to the center of the long axis of the tissue stack about two-thirds of the way to the end opposite the clip, while the 2^{nd} and 4^{th} sprays are directed to the center of the tissue stack. All 4 sprays to a single stack are done at a height of about 5 to 7.5 cm, generating a spray pattern of about 2.5 cm in diameter using a spray pulse duration of about 1 second each. The sprayer used is commercially available from Sally Beauty Supply, part #265035, Denton, Tex., USA. The amount of water dispensed from the spray bottle to each stack is consistent with the average amount of moisture absorbed by a tissue stack during post-urinary drying or cleansing of human skin as determined through a consumer panel. Immediately after spraying both stacks with all 4 sprays of water, the stacks are flipped over and placed on a respective felt sample surface so that the surface of the stack that has been directly sprayed with water is in contact with the felt sample surface.

The fifth step 150 involves placing a 1350 g block of brass (brass flat 360, Item #BF360/2212, commercially available from Metal Supermarkets, Cincinnati, Ohio, USA), measuring 8.26 cm in length, 3.81 cm in width, and 3.81 cm in height gently on each stack. The purchased brass has a footprint size as indicated above, but must be milled down in height, if necessary, to a target weight of 1350 g. The pressure applied by the block of brass is 4.1 kpascals which approximates actual use data from a clinical wiping study conducted with outside panelists in 2005 wherein the average wiping pressure was about 4.6 kpascals.

The sixth step 160 requires dragging the tissue stack and weight using the cotton candle string or flexible steel wire, described above, attached to the tissue stack. The stack is dragged a distance of about 20.3 cm over the felt sample surface during a period of about 15 seconds. The string or wire pulling the tissue stack (˜25 cm No. 36 Twine, Stay Clean Polished Twine, commercially available from Shuford Mills, Inc., Hickory, N.C., USA) and weight positioned on the tissue stack is kept parallel to the hard surface upon which the test is being conducted so as to not add or subtract normal force during the tissue dragging step 160. The rate of pull is kept constant rather than the force pulling the stack as starting and stopping the pull due to changes in resistance would yield different results.

The seventh step 170 is permitting inspection of the pills formed by each stack and left on the respective felt sample surfaces by one or more consumers. This inspection can be done in person, such as in-store, or not in-person, for example via a visual close-up using still photography or video camera recording. For example, the inspection may be done by airing the wet pilling test method and/or results produced from the wet pilling test method, on television for consumers to view.

An optional eighth step 180 is to collect data and graph and/or document the amount, size, distribution, surface area covered and/or density of the pills remaining on the felt sample surface. This step could be automated utilizing common and commercially available image analysis equipment and software.

Experimental results are determined by counting the number of noticeable piece(s), larger than 5 mm² in size, observed on the felt sample surface after execution of the wet pilling test method and recording the results in a laboratory notebook. Table 1 below summarizes the results obtained by this wet pilling test method of a comparison of two leading toilet tissue products on the market in August/September 2007.

TABLE 1
Demonstration results, 30 trial average

| | Brand C/Ultra Strong | Brand K |
|---|---|---|
| Product/Properties | Double Roll Format | Double Roll Format |
| Average # of Pieces | 0.63s* | 4.9 |

*s implies significantly different at 99% confidence interval

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for demonstrating to a consumer wet pilling property differences between two toilet tissue products, the method comprising the steps of:
a. subjecting a first toilet tissue product and a second toilet tissue product to a wet pilling test method, which produces results that demonstrate to a consumer the wet pilling property differences between the first and second toilet tissue products; and
b. presenting the results to the consumer.

2. The method according to claim 1 wherein the step of presenting the results to the consumer comprises airing a television commercial.

3. The method according to claim 1 wherein the step of presenting the results to the consumer comprises placing the results on the Internet.

4. The method according to claim 1 wherein the step of presenting the results to the consumer comprises distributing a print advertisement.

5. The method according to claim 1 wherein the step of presenting the results to the consumer comprises distributing the results on toilet tissue product packages.

6. The method according to claim 1 wherein the step of presenting the results to the consumer comprises displaying the results on an in-store display.

7. The method according to claim 1 wherein the step of presenting the results to the consumer comprises displaying the results on a billboard.

8. The method according to claim 1 wherein the step of presenting the results to the consumer comprises visually, numerically and/or graphically presenting the results to the consumer.

9. The method according to claim 1 wherein the results comprise the number of pills produced by each of the first and second toilet tissue products.

10. The method according to claim 1 wherein the results comprise the size of pills produced by each of the first and second toilet tissue products.

11. The method according to claim 1 wherein the wet pilling test method comprises the steps of:
a. applying moisture to the first and second toilet tissue products; and
b. wiping the moistened first and second toilet tissue products across a test surface such that the wet pilling property differences between the first and second toilet tissue products is visible to a consumer.

12. The method according to claim 11 wherein the test surface comprise felt.

13. The method according to claim 11 wherein the wiping step comprises a simulated, in-use wiping process.

14. A toilet tissue product package housing a toilet tissue product, the package comprising non-textual indicia that evidences to a consumer of the toilet tissue product that the toilet tissue product exhibits a wet pilling property different from another toilet tissue product.

15. The toilet tissue product package according to claim 14 wherein the non-textual indicia is selected from the group consisting of: pictures, graphs, drawings, representations, images, icons and mixtures thereof.

16. A marketing article comprising non-textual indicia that evidences to a consumer of a toilet tissue product that the toilet tissue product exhibits a wet pilling property different from another toilet tissue product.

17. The marketing article according to claim 16 wherein the non-textual indicia is selected from the group consisting of: pictures, graphs, drawings, representations, images, icons and mixtures thereof.

18. The marketing article according to claim 16 wherein the marketing article is selected from the group consisting of: print advertisements, in-store display advertisements, billboard advertisements, television advertisements, Internet advertisements and mixtures thereof.
